(19) United States
(12) Patent Application Publication
(10) Pub. No.: US 2019/0127667 A1
(43) Pub. Date: May 2, 2019

(54) CLEANING SOLVENT COMPOSITION

(71) Applicant: DIPSOL CHEMICALS CO., LTD., Tokyo (JP)

(72) Inventors: Takayuki YAMATOJI, Nagareyama-shi (JP); Akira HASHIMOTO, Nagareyama-shi (JP); Manabu INOUE, Nagareyama-shi (JP)

(21) Appl. No.: 16/309,374

(22) PCT Filed: Jul. 13, 2017
(86) PCT No.: PCT/JP2017/025524

§ 371 Date: Dec. 12, 2018

(30) Foreign Application Priority Data
Jul. 14, 2016 (JP) 2016-139601

(51) Int. Cl. C11D 7/50; C11D 7/26; C11D 7/32

(52) U.S. Cl. CPC C11D 7/5018; C11D 7/32; C11D 7/267

(57) ABSTRACT

Provided is a cleaning solvent composition that comprises a cis-1-chloro-3,3,3-trifluoropropene solvent and an additive, wherein the additive contains at least one type of compound selected from the group consisting of nitroalkanes and epoxides.

### TECHNICAL FIELD

The present invention relates to a cleaning solvent composition for use as an alternative solvent to chlorofluorocarbons, chlorine-based solvents, bromine-based solvents, and hydrocarbon-based solvents. More specifically, the present invention relates to a cleaning solvent composition which very rarely causes ozone destruction and global warming, is nonflammable, is highly safe with little influence on the human body, and is capable of cleaning an object to be cleaned without rusting the object.

### BACKGROUND ART

At present, hydrocarbon-based organic solvents, chlorine-based organic solvents, bromine-based organic solvents, and fluorine-based organic solvents (such as chlorofluorocarbons or hydrochlorofluorocarbons) are used as organic solvent-based cleaning agents. However, the hydrocarbon-based cleaning agents are flammable and dangerous, and the chlorine-based or bromine-based organic solvents have a problem in safety due to influence on the human body and the like. In addition, the fluorine-based solvents (such as chlorofluorocarbons or hydrochlorofluorocarbons) are restricted in use because they cause environmental problems such as global warming and ozone layer destruction. Under such circumstances, a hydrofluoroolefin (HFO)-based organic solvent having a low global warming potential (GWP) and a low ozone depletion potential, not having a flash point, and having a relatively high safety for human bodies is one candidate for an alternative cleaning agent to the aforementioned cleaning agents (for example, Japanese Patent Application Publication No. 2014-181405). However, in the case where an object to be cleaned is metallic, especially, made of an iron or copper material, the HFO-based organic solvent have a problem in that the object may rust when water is mixed into the cleaning liquid. In particular, cis-1-chloro-3,3,3-trifluoropropene, which is one of HFOs, has a low boiling point (39.0° C.) and therefore moisture in the air and the like are easily mixed into the cleaning liquid. For example, when cis-1-chloro-3,3,3-trifluoropropene is used as a vapor steam cleaning agent, the vapor is cooled to a low temperature in some cases, one of the purposes of which is to prevent leakage of the vapor. Such cooling causes a problem in that water in the air is condensed in the cooling part and mixed into the cleaning liquid, and an object to be cleaned (of an iron material) rusts due to the water thus mixed.

### SUMMARY OF INVENTION

The present invention has an object to provide a cleaning solvent composition which very rarely causes ozone destruction and global warming while maintaining cleaning performance and nonflammability and which is highly safe with little influence on the human body. The present invention has another object to provide a cleaning solvent composition which does not cause rusting of an object to be cleaned even when water is mixed.

The present inventors have conducted earnest studies to achieve the foregoing objects, and consequently have completed the present invention by finding that, when an nitroalkane alone is added, an epoxide alone is added, or a combination of an epoxide and an nitroalkane is added at an appropriate concentration to cis-1-chloro-3,3,3-trifluoropropene, the obtained composition is unlikely to cause rusting of an object to be cleaned even when water is mixed. In other words, the present invention provides a cleaning solvent composition comprising a cis-1-chloro-3,3,3-trifluoropropene solvent and an additive, wherein the additive comprises at least one compound selected from the group consisting of nitroalkanes and epoxides.

According to the present invention, it is possible to provide a cleaning solvent composition which very rarely causes ozone destruction and global warming while maintaining cleaning performance and nonflammability and which is highly safe with little influence on the human body. Moreover, it is possible to provide a cleaning solvent composition which does not cause rusting of an object to be cleaned even when water is mixed. The cleaning solvent composition of the present invention can be applied to any of metals, ceramics, plastics and the like as a base material to be cleaned, can be particularly suitable for a cleaning agent for metals, which are highly likely to rust due to moisture, such as iron, iron alloys, copper, and copper alloys and can be suitably used for cleaning various kinds of metal processed products, electronic parts and the like, such as precision parts, automobile parts, and household electronic parts.

### DESCRIPTION OF EMBODIMENTS

A cleaning solvent composition of the present invention comprises a cis-1-chloro-3,3,3-trifluoropropene solvent and an additive, wherein the additive comprises at least one compound selected from the group consisting of nitroalkanes and epoxides.

In the cleaning solvent composition of the present invention, a concentration of the cis-1-chloro-3,3,3-trifluoropropene solvent is preferably 80 to 99.9 wt %, more preferably 88 to 99.7 wt %, and most preferably 96 to 99 wt %.

As the nitroalkane used in the present invention, there are saturated C₁ to C₆ aliphatic nitrides, for example, nitromethane, nitroethane, 1-nitropropane and 2-nitropropane and the like, and the nitroethane is preferred. Each of these nitroalkanes may be used alone, or a mixture of two or more of them may be used. In the cleaning solvent composition of the present invention, a concentration of the nitroalkane is preferably 20 wt % or less, more preferably 12 wt % or less, and most preferably 4 wt % or less in 100 wt % of the cleaning solvent composition. Meanwhile, in the cleaning solvent composition of the present invention, the concentration of the nitroalkane is preferably 0.1 wt % or more, more preferably 0.3 wt % or more, and most preferably 1 wt % or more in 100 wt % of the cleaning solvent composition.

As the epoxide used in the present invention, there are: saturated C₁ to C₈ aliphatic epoxides, for example, epichlorohydrin, propylene oxide, butylene oxide, pentene oxide, cyclohexene oxide, and cyclopentene oxide; saturated C₁ to C₈ aliphatic ether epoxides, for example, glycidyl methyl ether; unsaturated C₂ to C₄ carboxylic acid epoxides, for example, glycidyl methacrylatel; and the like. Among them, the butylene oxide is preferable. Each of these epoxides may be used alone, or a mixture of two or more of them may be used. In the cleaning solvent composition of the present invention, a concentration of the epoxide is preferably 20 wt % or less, more preferably 12 wt % or less, and most preferably 4 wt % or less in 100 wt % of the cleaning solvent composition. Meanwhile, in the cleaning solvent composition of the present invention, the concentration of the epoxide is preferably 0.1 wt % or more, more preferably 0.3 wt % or more, and most preferably 1 wt % or more in 100 wt % of the cleaning solvent composition.

In the case where the cleaning solvent composition of the present invention comprises both a nitroalkane and an epoxide, a total concentration of the nitroalkane and the epoxide in the cleaning solvent composition of the present invention is preferably 20 wt % or less, more preferably 12 wt % or less, further preferably 8 wt % or less, and most preferably 4 wt % or less in 100 wt % of the cleaning solvent composition. Meanwhile, in the cleaning solvent composition of the present invention, the total concentration of the nitroalkane and the epoxide is preferably 1 wt % or more, and more preferably 2 wt % or more in 100 wt % of the cleaning solvent composition.

The cleaning solvent composition of the present invention preferably comprises a nitroethane of 1 wt % to 2 wt %, both inclusive, and a butylene oxide of preferably 1 wt % to 2 wt %, both inclusive, in 100 wt % of the cleaning solvent composition.

The cis-1-chloro-3,3,3-trifluoropropene solvent used in the present invention may contain another solvent as long as the cis-1-chloro-3,3,3-trifluoropropene solvent can maintain cleaning performance and nonflammability. Such solvents include trans-1,2-dichloroethylene, lower aliphatic alcohols, and the like. These other solvents can improve the detergency of the cis-1-chloro-3,3,3-trifluoropropene solvent, in particular, against solid surfaces. These other solvents may be used in combination. Meanwhile, it is unfavorable that the amount of such other solvent added is excessively contained, because the nonflammability may not be maintained in some cases. As the lower aliphatic alcohols, there are C₁ to C₃ alcohols, for example, methanol, ethanol, isopropanol, and the like. In the cis-1-chloro-3,3,3-trifluoropropene solvent, a concentration of the lower aliphatic alcohol is preferably 30 wt % or less, more preferably 20 wt %, and further preferably 15 wt % or less in 100 wt % of the total amount of the cis-1-chloro-3,3,3-trifluoropropene and the lower aliphatic alcohol. Meanwhile, in the cis-1-chloro-3,3,3-trifluoropropene solvent, the concentration of the lower aliphatic alcohol is preferably 1 wt % or more, more preferably 5 wt % or more, and further preferably 10 wt % or more in 100 wt % of the total amount of the cis-1-chloro-3,3,3-trifluoropropene and the lower aliphatic alcohol.

In the cis-1-chloro-3,3,3-trifluoropropene solvent, a concentration of the trans-1,2-dichloroethylene is preferably 55 wt % or less, more preferably 50 wt % or less, and further preferably 40 wt % or less in 100 wt % of the total amount of the cis-1-chloro-3,3,3-trifluoropropene and the trans-1,2-dichloroethylene. Meanwhile, in the cis-1-chloro-3,3,3-trifluoropropene solvent, the concentration of the trans-1,2-dichloroethylene is preferably 5 wt % or more, more preferably 10 wt % or more, and further preferably 20 wt % or more in 100 wt % of the total amount of the cis-1-chloro-3,3,3-trifluoropropene and the trans-1,2-dichloroethylene.

A method of cleaning an object to be cleaned by using the cleaning solvent composition of the present invention is not limited to a particular one, but any known cleaning method can be appropriately used depending on a base material to be cleaned, the shape, and the like. For example, in the case of a metal part, the metal part may be immersed into a container containing a cleaning solvent composition solution (solution cleaning), immersed into a vapor space containing the solvent composition (vapor steam cleaning), sprayed with an aerosol or other atomized form of the solvent composition (aerosol cleaning), or cleaned in any combination of the foregoing cleaning methods.

Next, the present invention is explained by using Examples and Comparative Examples. The present invention is not limited to these Examples.

### EXAMPLES

### Example 1

A solvent composition was prepared by adding nitroethane (2 wt %) to cis-1-chloro-3,3,3-trifluoropropene (98 wt %).

### Example 2

A solvent composition was prepared by adding butylene oxide (2 wt %) to cis-1-chloro-3,3,3-trifluoropropene (98 wt %).

### Example 3

A solvent composition was prepared by adding nitroethane (2 wt %) and butylene oxide (1 wt %) to cis-1-chloro-3,3,3-trifluoropropene (97 wt %).

### Example 4

A solvent composition was prepared by adding nitroethane (1 wt %) and nitromethane (1 wt %) to cis-1-chloro-3,3,3-trifluoropropene (98 wt %).

### Example 5

A solvent composition was prepared by adding nitroethane (2 wt %), butylene oxide (1 wt %), and methanol (10 wt %) to cis-1-chloro-3,3,3-trifluoropropene (87 wt %).

### Example 6

A solvent composition was prepared by adding nitroethane (2 wt %), butylene oxide (1 wt %), and trans-1,2-dichloroethylene (47 wt %) to cis-1-chloro-3,3,3-trifluoropropene (50 wt %).

### Comparative Example 1

SC-52 (manufactured by DIPSOL CHEMICALS Co., Ltd.) containing n-propyl bromide (NPB) as a main component was used as a solvent composition.

### Comparative Example 2

Cis-1-chloro-3,3,3-trifluoropropene (100 wt %) was used as a solvent composition.

### Comparative Example 3

A solvent composition was prepared by adding methanol (10 wt %) to cis-1-chloro-3,3,3-trifluoropropene (90 wt %).

### Comparative Example 4

A solvent composition was prepared by adding trans-1,2-dichloroethylene (50 wt %) to cis-1-chloro-3,3,3-trifluoropropene (50 wt %).

Examples 1 to 6 and Comparative Examples 1 to 4 were tested in the flash point, the detergency, and the occurrence of rusting in both the cases where no water was added and where water was added in an amount of 0.1 wt % relative to the total weight of the solvent composition. The test methods thereof are as follows.

Flash Point: Tag closed cup method
Detergency Test: A test piece was prepared from a precleaned SPCC mild steel plate (50×70×0.5 mm) by forming a circular recess in the plate by Erichsen and applying a rust preventive oil (P5957 manufactured by Nihon Kohsakuyu Co., Ltd.) to the recess (an amount of oil applied: 25 mg/dm²). This test piece was cleaned by being immersed in each of the solvent compositions at room temperature for 3 minutes. After cleaning, the test piece was dried and the amount of residual oil was measured by the gravimetric method. The detergency in degreasing was determined to be good when the amount of residual oil was less than 2 mg/dm² that is equivalent to that of SC-52S.
2 mg/dm² or more x
Below 2 mg/dm² ∘
Rusting test: A precleaned SPCC mild steel plate (5×10×0.5 mm) was immersed in each of the solvent compositions at room temperature for 100 hours, and then the occurrence of rusting was examined.
No rust ∘
With rust x

TABLE 1

| | | | | | | Rusting |
|---|---|---|---|---|---|---|
| | Composition (wt %) | | | Flash Point | | Prevention |
| | Solvent | Additive | Water Addition | (° C.) | Detergency | (Metal Piece) |
| Example 1 | Cis-1-chloro-3,3,3-trifluoropropene (98) | Nitroethane (2) | Not Added | None | ∘ | ∘ |
| | | | 0.1 wt % | None | ∘ | ∘ |
| Example 2 | Cis-1-chloro-3,3,3-trifluoropropene (98) | Butylene oxide (2) | Not Added | None | ∘ | ∘ |
| | | | 0.1 wt % | None | ∘ | ∘ |
| Example 3 | Cis-1-chloro-3,3,3-trifluoropropene (97) | Nitroethane (2) | Not Added | None | ∘ | ∘ |
| | | Butylene oxide (1) | 0.1 wt % | None | ∘ | ∘ |
| Example 4 | Cis-1-chloro-3,3,3-trifluoropropene (98) | Nitroethane (1) | Not Added | None | ∘ | ∘ |
| | | Nitromethane (1) | 0.1 wt % | None | ∘ | ∘ |
| Example 5 | Cis-1-chloro-3,3,3-trifluoropropene (87) | Nitroethane (2) | Not Added | None | ∘ | ∘ |
| | Methanol (10) | Butylene oxide (1) | 0.1 wt % | None | ∘ | ∘ |
| Example 6 | Cis-1-chloro-3,3,3-trifluoropropene (50) | Nitroethane (2) | Not Added | None | ∘ | ∘ |
| | Trans-1,2-dichloroethylene (47) | Butylene oxide (1) | 0.1 wt % | None | ∘ | ∘ |
| Comparative | SC-52 | | Not Added | None | ∘ | ∘ |
| Example 1 | | | 0.1 wt % | None | ∘ | ∘ |
| Comparative | Cis-1-chloro-3,3,3-trifluoropropene | | Not Added | None | ∘ | ∘ |
| Example 2 | (100) | | 0.1 wt % | None | ∘ | x |
| Comparative | Cis-1-chloro-3,3,3-trifluoropropene (90) | | Not Added | None | ∘ | ∘ |
| Example 3 | Methanol (10) | | 0.1 wt % | None | ∘ | x |
| Comparative | Cis-1-chloro-3,3,3-trifluoropropene (50) | | Not Added | None | ∘ | ∘ |
| Example 4 | Trans-1,2-dichloroethylene (50) | | 0.1 wt % | None | ∘ | x |

1. A cleaning solvent composition comprising a cis-1-chloro-3,3,3-trifluoropropene solvent and an additive, wherein the additive comprises at least one compound selected from the group consisting of nitroalkanes and epoxides.

2. The cleaning solvent composition according to claim 1, wherein the additive comprises a nitroalkane.

3. The cleaning solvent composition according to claim 2, wherein an amount of the nitroalkane is 0.1 wt % to 20 wt %, both inclusive.

4. The cleaning solvent composition according to claim 2, wherein the nitroalkane comprises a nitroethane.

5. The cleaning solvent composition according to claim 1, wherein the additive comprises an epoxide.

6. The cleaning solvent composition according to claim 5, wherein an amount of the epoxide is 0.1 wt % to 20 wt %, both inclusive.

7. The cleaning solvent composition according to claim 5, wherein the epoxide comprises a butylene oxide.

8. The cleaning solvent composition according to claim 1, comprising:
a nitroethane of 1 wt % to 2 wt %, both inclusive; and
a butylene oxide of 1 wt % to 2 wt %, both inclusive.

9. The cleaning solvent composition according to claim 1, wherein the cis-1-chloro-3,3,3-trifluoropropene solvent further comprises a lower aliphatic alcohol.

10. The cleaning solvent composition according to claim 1, wherein the cis-1-chloro-3,3,3-trifluoropropene solvent further comprises trans-1,2-dichloroethylene.

11. The cleaning solvent composition according to claim 1, wherein the additive comprises a nitroalkane and an epoxide, and a total concentration of the nitroalkane and the epoxide in the cleaning solvent composition is 1 wt % to 20 wt %, both inclusive.
